(19) United States
(12) Patent Application Publication
(10) Pub. No.: US 2015/0331549 A1
(43) Pub. Date: Nov. 19, 2015

(54) SYSTEM, METHOD, DEVICE, AND COMPUTER PROGRAM FOR AT-GLANCE VISUALIZATION OF EVENTS BASED ON TIME-STAMPED HETEROGENEOUS DATA COMPONENTS

(71) Applicant: Pryv S.A., Morges (CH)

(72) Inventors: Pierre-Mikael LEGRIS, Morges (CH); Simon GOUMAZ, Geneve (CH); Frederic MAUCH, Geneve (CH)

(21) Appl. No.: 14/699,615

(22) Filed: Apr. 29, 2015

Related U.S. Application Data
(60) Provisional application No. 61/996,656, filed on May 14, 2014.

(51) Int. Cl. G06F 3/0481; G06F 3/0484; G06T 11/20

(52) U.S. Cl. CPC G06F 3/0481; G06T 11/206; G06F 3/04845; G06F 3/04817

(57) ABSTRACT

A method for graphically representing information on a display, including the steps of displaying a first icon associated with a start date, displaying a second icon associated with an end date, displaying an first object that is associated with a first date that lies between an interval of the start date and the end date, displaying a second object that is associated with a second date that lies between the interval of the start date and the end date, changing at least one of the start date and the end date such that the first date lies outside the interval of the start date and the end date, and removing the display of the first object.

### CROSS-REFERENCE TO RELATED APPLICATION

This application claims the benefit of priority to U.S. Provisional Application No. 61/996,656, filed May 14, 2014, the entire contents thereof herewith incorporated by reference.

### FIELD OF THE INVENTION

The present invention related to a system, method, device, and computer program that allows a user to view a limited number of events that are based on an unlimited number of heterogeneous data components, all data components being time-stamped and contextualized and displayed to a single graphical user interface having a fixed display surface.

### BACKGROUND OF THE INVENTION

In the field of graphical user interfaces that are used for visualizing data for users, commonly a variety of different applications have to be used. For example, if a user uses a tablet computer and wants to look up a location tag from a site he checked in via a social media network, photos from his last vacation trip, a calendar entry, and his performance at a recent jogging run, all of this data being heterogeneous but time-stamped and contextualized data, he usually needs to use and start four different applications, including the social media application, a photo viewer, a calendar software such as Outlook™, and a sports tracking software such as SportsTracker™. In addition, not only does he need to start various applications and software, but also the display of these events for the user may be time consuming as these applications and software my not have specific and easy-to-use viewing capabilities. For example, to find a location tag, the user may have to scroll down a timeline of the social media application to see the location tag, and for viewing photos, the user will most likely have to browse through various folders.

Therefore, in light of the above deficiencies of the background art, there is a strong need for improved visualization methods and systems for viewing heterogeneous and time-stamped data from various sources.

### SUMMARY OF THE INVENTION

According to one aspect of the present invention, a method for graphically representing information on a display is provided. Preferably the method includes a step of displaying a first icon representative of a start date, displaying a second icon representative of an end date, displaying an first object that is associated with a first date that lies between an interval of the start date and the end date. Moreover, the method preferably further includes the steps of displaying a second object that is associated with a second date that lies between the interval of the start date and the end date, changing at least one of the start date and the end date such that the first date lies outside the interval of the start date and the end date, and removing the display of the first object.

According to another aspect of the present invention, a non-transitory computer readable medium having computer instructions recorded thereon is provided, the computer instructions configured to perform a method when executed on a computer. Preferably, the method includes the steps of displaying a first icon associated with a start date on a display, displaying a second icon associated with an end date on the display, and displaying an first object that is associated with a first date that lies between an interval of the start date and the end date on the display. In addition, the method further preferably includes the steps of displaying a second object that is associated with a second date that lies between the interval of the start date and the end date on the display, changing at least one of the start date and the end date such that the first date lies outside the interval of the start date and the end date, and removing the display of the first object from the display

The summary of the invention is neither intended nor should it be construed as being representative of the full extent and scope of the present invention, which additional aspects will become more readily apparent from the detailed description, particularly when taken together with the appended drawings.

### BRIEF DESCRIPTION OF THE DRAWINGS

FIG. 1 shows a computer system for implementing the at-glance visualization system or method according to one aspect of the present invention;

FIG. 2 shows an exemplary schematic view of the steps performed by at-glance visualization method according to an aspect of the present invention;

FIG. 3 shows an exemplary graphical user interface displaying a summary of events on a data visualization device according to another aspect of the present invention;

FIG. 4 shows a screenshot of an exemplary graphical user interface displaying a summary of events on a data visualization device according to another aspect of the present invention;

FIGS. 5A-5B shows exemplary graphical user interfaces when a user modifies a display area size of the graphical user interface;

FIGS. 6A-6C shows exemplary graphical user interfaces when a user modifies a display time of the graphical user interface;

FIG. 7 shows a screenshot of an exemplary graphical user interface displaying a single expanded view of an event on a data visualization device according to yet another aspect of the present invention; and

FIG. 8 shows an exemplary graphical user interface according to still another aspect of the present invention.

Herein, identical reference numerals are used, where possible, to designate identical elements that are common to the figures. The images in the drawings are simplified for illustrative purposes and are not necessarily depicted to scale.

### DETAILED DESCRIPTION OF THE EMBODIMENTS

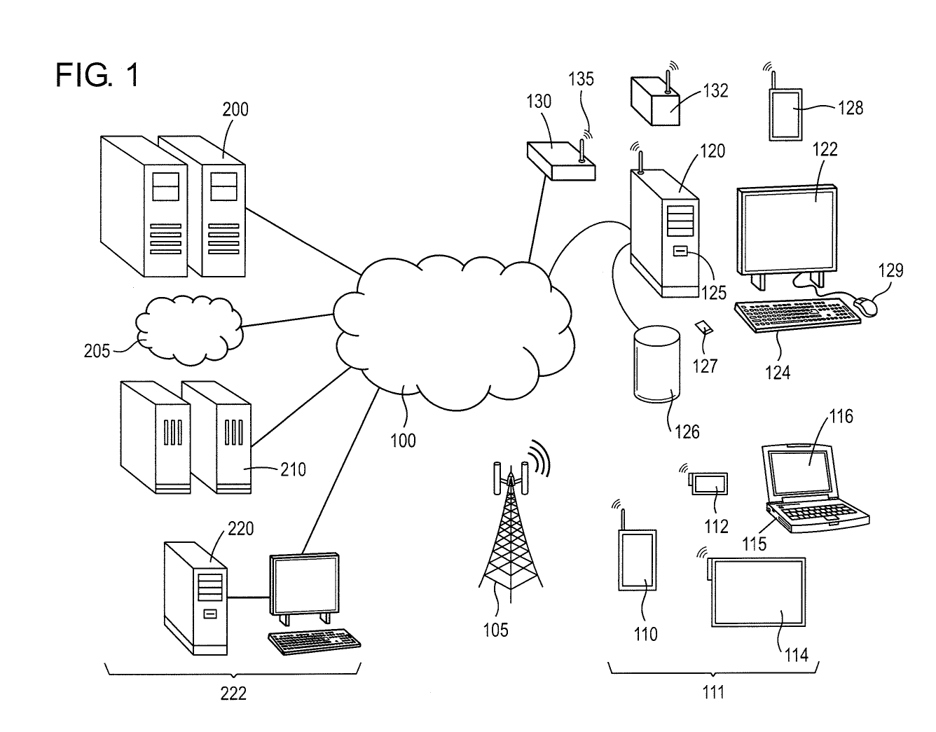

FIG. 1 shows an exemplary system for implementing the at-glance visualization method and system. The system shown consist of data providing devices or elements 222 such as servers 200, 210, networked computers 220, and other remote storage mediums such as cloud-based storage medium or server farm 205, local storage elements like hard drive 126, network drive 132, portable and removable storage devices 127 such as but not limited to portable drives, flash drives, floppy disks, optical storage media, CD-Rom, DVD-Rom, BluRay™, and other local storage mediums, and data visualization devices or elements 111 such as computers 120, wireless terminal devices 128, mobile network devices such as smartphones 110, tablet computers 114, mobile display devices 112, for example automotive or marine electronics, smart televisions, set-top boxes for televisions like GoogleTV™, Roku™, AppleTV™, laptop computers 118 that connect to a mobile data system 105. Data providing devices 222 and data visualization devices 111 are directly or indirectly connected to each other via network 100, for example the Internet 100 or via a local area network generated by router 130. Servers 200, 210 and cloud-based storage medium or server farm 205 are also connected to network 100 and include various databases, for example cloud or local databases that store various kind of content. For example, the servers 200, 210 can include web-accessible data storage servers such as commercial remote and cloud-based storage systems like DropBox™, TeamDrive™, Amazon Cloud Drive™, SkyDrive™, BitTorrent™, Apple ICloud™, personal or commercial file transfer protocol (FTP) server hosting services, virtual file hosting services, image data servers like Shutterfly™, Picasa™, Flickr™, video servers such as YouTube™, DailyMotion™, music servers like iTunes™, gaming server portals to access gaming history, performance data, scores, access portals to Social Media sites like Instagram™, Facebook™, Google+™, MySpace™ FourSquare™, Twitter™, Vine™, and other services that can store personal, shared, published, or other data records, such as but not limited to sports and tracking services like Endomondo™, Runkeeper™, SportsTracker™, AlpineReplay™, OruxMaps™, basic text files such as notepad entries, UNIX™ text files, database access systems such as Oracle or Microsoft Access™ database systems, data servers with economic, political, and financial data, bank servers with account and portfolio information from personal accounts and securities trade data, Outlook™ or Google™ calendar and task servers, mail servers. Computer 220 can be configured as a webserver or as another device that can share data components with the network 100. All servers 200, 205, 210 and computer 220 can provide for data source components for the at-glance visualization system.

Next, data visualization elements 111 can be used to perform and interact with the at-glance visualization system and method. As an example, computer 120 is shown with a keyboard 124 and a mouse 129 as a data input devices that can be operated by user U, and a display screen 122 that can be used for displaying a graphical user interface that will show the results and operative interface of the at-glance visualization method and system, and also includes a drive 125 for reading removable storage devices 127. Removable storage device 127 is a non-transitory medium that can store a computer-readable program thereon in the form of computer readable instructions. The computer program thereon can be configured such that it is capable of and configured to perform the method of at-glance visualization, when the instructions are performed on computer 120. Similarly, the computer program can also be adapted to perform the method of at-glance visualization on other data visualization devices or elements 111 such as smart phone 110, tablet computer 114, portable computer or laptop 116 having a removable storage medium reader 115, terminal device 112 such as a car electronic device, portable video player, marine electronics, wireless terminal 128.

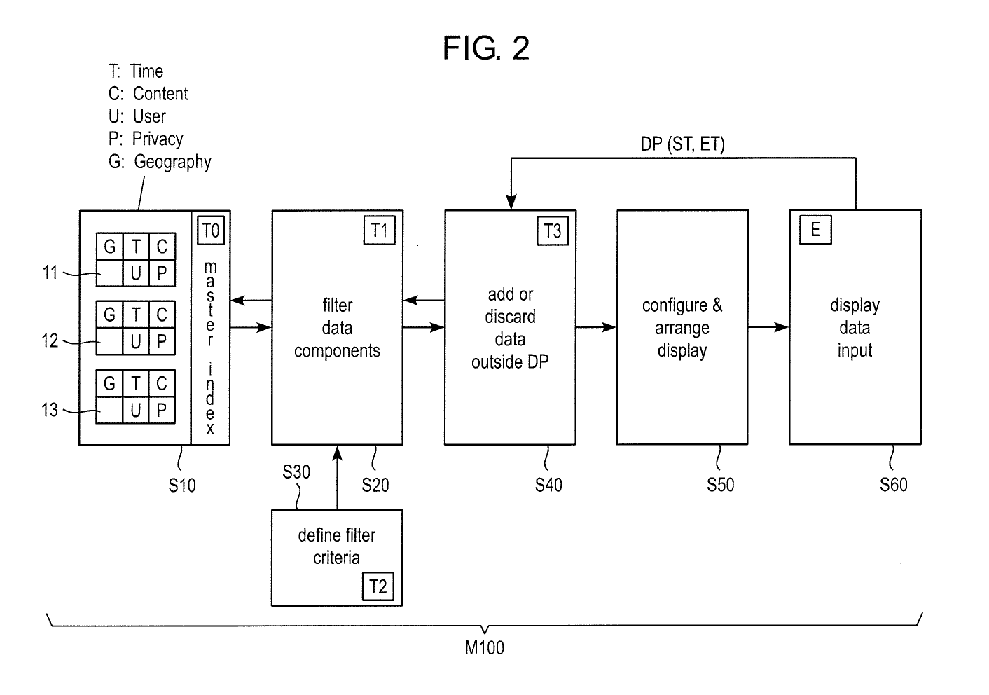

The method for at-glance visualization M100 is schematically represented in FIG. 2 and can be executed at various software levels, for example at the operation system level of the data visualization devices 111, or as an application or software that is run on the pre-existing operation system. It can also be implemented purely web-based, and be accessible via a web browser that is operated on the data visualization devices 111 and run from a remote web server 200, 210, or as a plug-in or java applet to an already existing web browser, or be implemented on a local area network server. It is also possible that the operation system of a data visualization devices 111 is based on the method for the at-glance visualization M100 itself, for example a device that is mainly designed for data viewing, for example a dedicated set-top box for display of the graphical user interface on a large screen. A hardware processor of data visualization devices 111 or data providing device can be used to execute computer instruction code that allows to perform method M100 on the respective devices 111, 222.

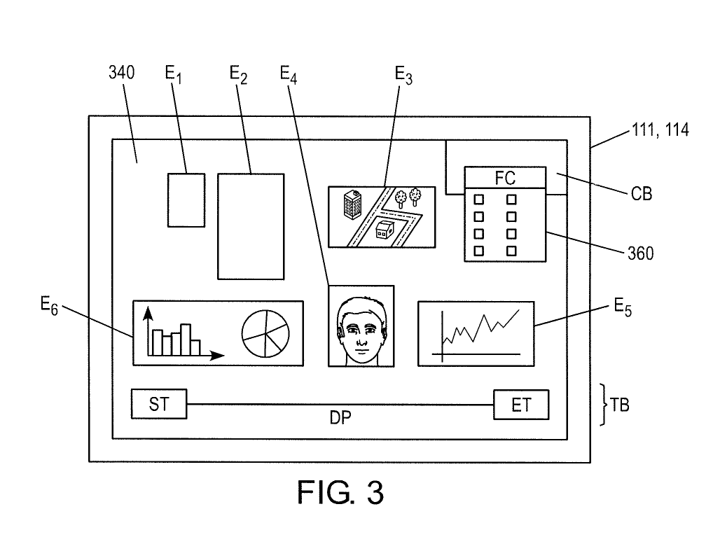

The method for at-glance visualization M100 accesses a variety of heterogeneous data source components 11, 12, 13 that are stored throughout the various data providing devices 222, but data source components can also be stored on local memory such as hard drives of the data visualization devices 111. The data source components 11, 12, 13 are all time-stamped, i.e. have at least one time and date associated to it, and can be contextualized with one or more contexts. Method M100 is configured to provide a graphical user interface 340 for displaying on a single non-scrollable screen, at least some of the data source components 11, 12, 13, to display a summary of events E. The summary of events E is displayed on a single display graphical user interface that is expandable and reducible in size, but is not scrollable, as shown in FIG. 3. This interface 340 enables a user U to seize in an a single, at-glance view the summary of events E that happened in a defined period DP, and the representation and manipulation of the interface 340 allows the user to grasp the interaction and correlation between events E, exemplary shown as events E₁ to E₆. Various different data source components 11, 12, 13 can thereby be merged and visualized as events E, thus enabling the user U to gain a better perspective of various different events, and find more interactions. Each event E corresponds thereby to a single data source component 11, 12, 13. Events E are thereby aggregated and organized in a way that all available information with a defined period DP is condensed on a defined surface, with no need for scrolling out of the interface 340, and no overlap of different icons of graphical elements that represent the events E. In a variant, it is also possible that one event E is associated to two or more data source elements 11, 12, 13 that have a very similar structure, for example a series of lap times of a co-kart race event, so that the lap times and distance raced can be overlapped and compared.

Data source components 11, 12, 13 are digital pieces of data that are all time-stamped with time T, and can be contextualized by context C with tags and metadata, can be associated to one or more users U, and can have certain privacy settings P, and associated to different geographic areas or locations G. The user can filter events based on time T, context C, user U, privacy P, and geography G, and the user can change the filter settings to narrow or increase the scope of events E that will be visualized. For example, components 11, 12, 13 can originate from various different and heterogeneous applications, and can include but are not limited to photos, photo albums, videos, audio, multimedia, three-dimensional and two dimensional animations, virtual tours, activity tags, location tags, for example check-in data to sites like airports, museums, restaurants, tracked sports routes and laps associated to map data, calorie, speed, altitude, distance information, and summaries and statistics for activities and sports such as walking, jogging, skiing, snowboarding, kayaking, rowing, cycling, handwritten notes, recipes, do-it lists, web pages with uniform resource locators (URL), data tables, numerical values, contacts, maps with location information, stock exchange information, account information, portfolio information and associated graphs, electronic dashboards for providing past and present information, such as dashboards for home security system remove access and data log, home heating, air conditioning, ventilation (HVAC) systems, spending reports, historic status updates from social media networks, e-mails, text messages, multimedia messages, telephonic records and associated data, voicemails, video mails, business records, medical records, history of medical visits, medication records, health status records, electronic calendar entries and reminders, sports scores, sports match summaries, grades from exams.

Moreover, each data source component 11, 12, 13 is further linked to tags for example in the form of metadata that classifies the underlying data into one or more context C, associated to one or more users U, tagged with time information T, tagged with specific coordinates or names of geographic locations and areas, and tagged with privacy settings P. For example photos can be tagged with the people or users U that are present in the photo, but also tagged with the author of the photo, including a date and time T of taking the photo, and a time period of the vacation, time of uploading the photo to a server, and users U who are authorized to view the photo. This allows for a user U that is logged in the at-glance visualization system to view his photos, but also photos of other users that have made the photos available to user U. Moreover, the photos can also be associated with various information on context C, describing the activity, photo captions, etc. Notes, reminders, calendar entries can be date-stamped with time information T as to their date of creation, and can be associated with one or more users U, including the author creating the event, and users that the event is addressed to. Tracking records of sports and other events can be associated to a user U, can include a time period of the event including a start and stop time, and a date of the event. The context C can be an association of the data with different categories, and typical categories can be based on the type of underlying data of the data source component 11, 12, 13, including but not limited to photos, videos, tracking coordinates, notes, text, history data curves, calendar entries, reminders, do-to list, emotions, weather, activity, historic events. Data source components 11, 12, 13 can therefore include one or more tags in the associated metadata. In addition, data source component 11, 12, 13 can also be classified and tagged based on different events classifications as context C such as vacation, specific trips, specific events, business, financial data, health data, sports, family, friends, check-ins to specific sites, shopping. Moreover, data source components 11, 12, 13 can further be the classified based on a privacy setting P as a tag, for example family events, events that are private and confidential to one individual user U or a group of users U, and confidential and group-accessible business events, so that events E of different privacy categories can be reproduced by the at glance visualization method.

The method for at-glance visualization M100 is schematically shown in FIG. 2, in which first a search step S10 is performed on a periodic basis, at random intervals, or as soon as a new data providing device 222 is detected and logged into the at-glance visualization system, to search all the available data providing devices 222, and the data visualization devices 111 that are acting in a capacity to store and provide data source components, to look for data source components 11, 12, 13 that can be used for the at-glance visualization. In this step, via a graphical user interface, it is possible that the user selects and designates devices, folders, subfolders, drives, cloud areas, servers, accounts, dashboards that will deliver data source components 11, 12, 13 for the at-glance visualization, or that an automatic scan is performed. Thereafter, all these locations are searched for data source components that are eligible for being displayed with the at-glance visualization system. For example, data source components 11, 12, 13 may have a dedicated electronic data format, or may be certain file types. The at-glance visualization system can be configured to support certain file and data formats, and only data source components 11, 12, 13 of such file and data formats will be eligible for at-glance visualization. Once the search is performed, a master index table T0 is created or updated for facilitating the access to these data source components. However, it is also possible that these locations of the data source components 11, 12, 13 are predefined and do not have to be searched, and step S10 merely performs a search of eligible components, and a creation and update of a master index table T0 with all the eligible data source components found.

Step S10 may also perform accesses to different web-based portals and file-share portals of web-based data services, social media sites, and file sharing servers. For this purpose, with step S10, an agent can be called upon that includes username and password information of a user registered at the service, portal access information, and the requisite protocols to access data, for example the specific application programming interfaces (API), extensible markup language (XML) or JavaScript™ object notation (JSON) format the file transfer protocol (FTP), proprietary protocols of the web-based data service. For example, to access status updates, geographic location tags, and photos from a user U, this data being displayable as an event E by the at-glance visualization system, the agent can be configured to operate the Graph API of the Facebook™ platform, and can on a period basis, or based on an external trigger signal, access such Facebook content and include it in the eligible data source components 11, 12, 13 of the at-glance visualization system. In step S10, it is also possible that the method makes copies of the data source components 11, 12, 13 to store local copy in a local drive 126.

Next, a filtering step S20 is performed, in which the master index table T0 is used to generate a first table T1 having relevant data source components from the eligible ones, to reduce the quantity of data source components 11, 12, 13 that will ultimately be selected for the display of the summary of the events E. Step S20 can perform a filter based on context C, user U, geography G, and privacy P on the entries of master index table T0, or can perform another type of filter on the entries of master index table T0. The data source components 11, 12, 13 that will result from the filtering step S20 will be indexed and listed in first table T1, having less data entries than master index table T0. In this step, a filter algorithm can be applied to the data entries of table T1 by filtering the data based on a filter that has a series of filter criteria FC. One aspect of the filtering step S30 is to simply apply a filter of data source components 11, 12, 13 based on the user that is logged into and is using the data visualization device 111, or a selection of another one or more users U, and the user profile of the corresponding user. Any data source component 11, 12, 13 that is not associated to the user U can be disregarded and not listed or registered in first table T1. Upon login of the user to the data visualization device 111 and the at-glance graphical user interface 340 appears, and only events E appear that are based on data source components 11, 12, 13 linked to the specific logged-in user. Upon logging out by the user, these user-specific events E will disappear.

The filter criteria FC can be defined by a setting and analysis step S30, in which filter criteria FC is generated based on various factors including different factors of context C, different geographic locations G of the data visualization device 111, or a geographic area specified by the user. Different geographic locations and areas can be preset or detected via a global positioning system or by using other types of geographic data, or based on the local network or mobile cell data to which the data visualization device 111 is connected to. Also, pre-defined geographic areas such as “home,” “work,” “vacation house,” “beach,” “resort,” can be defined, and first table T1 can be built by discarding any data source components 11, 12, 13 that are not associated with that pre-selected, defined, or present geographic area based on the presence of location tags G. Another filter criteria FC could be the filtering of data source components 11, 12, 13 into different privacy settings P, such as private, family, user groups, and business events. As an alternative, another way of defining the filter criteria FC can be by using use a history of user interaction with the displayed events E and the underlying data source components 11, 12, and 13 on the graphical user interface 340, and thereby favor the selection of data source components 11, 12, 13, that will be most likely selected and used by the user of a data visualization device 111. In addition, the filter criteria FC can be based on predictive analytics of the user's behavior with the displayed events E of the at-glance system.

Moreover, it is also possible that filter criteria FC is based on a combination of various factors, for example by using a more complex data analysis than simply filtering the data source components based on a context C that uses available metadata of the data source components 11, 12, 13, and can generate an algorithm for filtering based on two or more criteria C in a dynamical way, or gives statistical preference to certain types of data source components 11, 12, 13. In a variant, the user U may be able to directly choose different context C he is interested in viewing, for example by reading user settings of desired and undesired context C, for example as shown in FIG. 3 with a slide-down or pop-up menu 360 in a control bar CB of the graphical user interface 340 that allows to select different context C to compose a filter criteria FC to permit or prevent the showing of different events E in the summary based on context types, for example sports-related events, photos, videos, songs, all audio-visual material, maps, family photos, personal photos, geographic tracking such as routes, time functions such as stock market evolution, portfolio evolution, temperature profiles, posted notes. This would allow a user U to directly control the data source elements 11, 12, 13 for the events E.

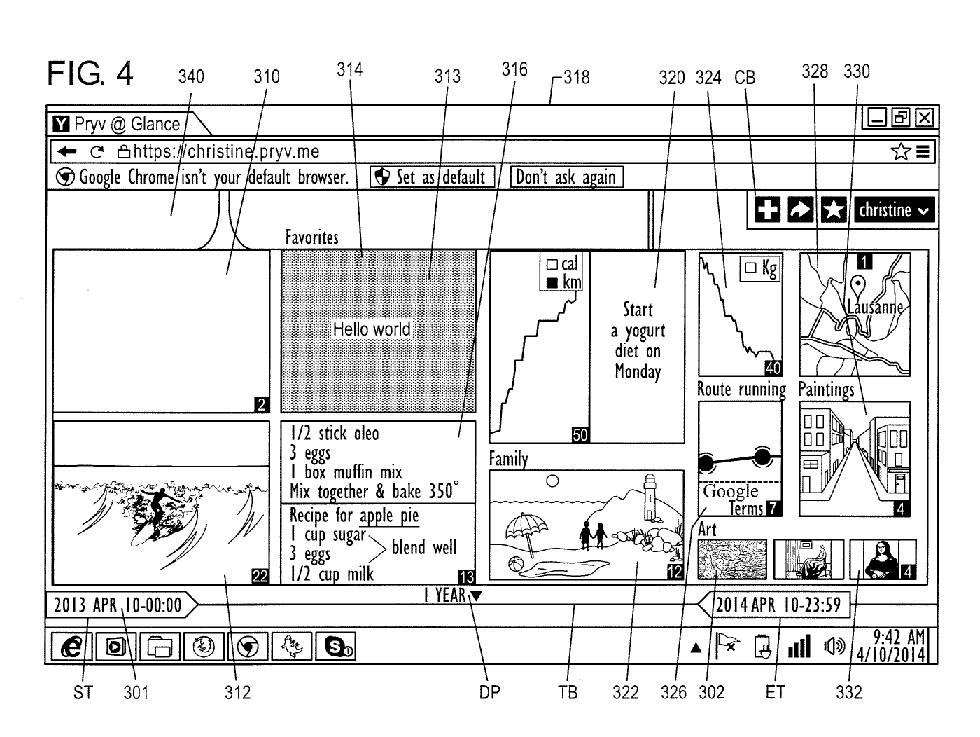

For example, step S30 can use statistical analysis of the behavior of user U with the events E on the graphical user interface. As shown in FIG. 4, an exemplary table 114 as a data visualization device 111 is shown, having events E₁ to E₅ with start time ST and end time ET displayed. Events E can be selected and expanded to a detailed view by touching or double-clicking on the displayed icons or graphical objects, and therefore allows a user U to interact with the events E₁ to E₅ so that more detail can be shown. Also, it is possible that user U deletes an event E after selecting it for the expanded view. Therefore, step S30 can include a counter that can count time durations that a user U has spent looking at an expanded event E, until the event is reduced to its normal view, and also counts a number of times a specific event E has been selected to count a number of selection for different events. Thereafter, different duration times and numbers of selection associated to specific events E can be recorded, and this data can be used for statistical analysis to see which types of events E are more often and longer used compared to other types of events. Duration times of event selection and number count of event selection can be compared to different metadata, including context C, privacy P, geography G to see what types of events are more popular with user U. Moreover, step S30 can also keep track of a user deleting certain types of events from the graphical user interface, indicating a disfavor of the particular user for such event or event types.

Based on such results, step S30 is configured to create a user-specific second table T2 that includes records of user U and duration times of event selection, number count of event selection, and deletion of events associated with a specific event E₁ to E₅. As all events are associated to different metadata such as context C, privacy P, geography G, user U, with statistical methods it can be analyzed which events are more popular or more frequently used by user. This permits to establish for each user U a past use profile based on his past use of the at-glance visualization system. For example, is a user U mostly uses the system to view photos and to display maps of his jogging routes, and this past usage would be recorded in second table T2 for further statistical analysis. The step S40 would generate a dynamic filter criteria DFC that would give statistical preference to display more photos and jogging routes as events E₁ to E₅. This dynamic filter criteria DFC can be based on an evolutive algorithm that can change as the behavior of the user U changes. Also, predictive algorithms can be applied to new data source components that are available and are newly registered at the master index table T0.

In step S40 data source components 11, 12, 13 are verified whether they are part of the defined display period DP or time interval, and are either discarded or added to the index stored in a third table T3. Thereby this step performs a simple time-based filter on the entries of first table T1. Display period DP with start time ST and end time ET is usually received by step S60 that builds and manages the display of the summary of events E on graphical user interface 340, but can initially be set to a default value. Display period DP can be freely set from being infinitely small to infinitely large. Also, as a default value upon start-up of the data visualization device 111 and the method M100, display period DP can be set to have an end time ET that corresponds to the present time and date, and a start time ST such that the DP is a specific pre-selected period, for example one month, one week, etc. Data source components are discarded or added based on the DP setting, and a third data table T3 is created, managed, and updated, having less or the same amount of data entries as the first table T1. As data source components 11, 12, 13 are all time-stamped with a specific time and date, all the data source components that do not fit into display period DP are not registered in third table T3, and the remaining components 11, 12, 13 that have a time-stamp within the display period DP will be indexed and registered into third table T3 or data structure for further processing by method M100. In case a data source component 11, 12, 13 has more than one time stamp, or has a specific time period associated thereto, step S40 can index and register all the components 11, 12, 13 into third table T3 that have at least one of the time-stamps that is covered by display period DP, and in the case of a specific time period, will select the component if the specific time period is at least partially covered by the DP.

In a variant, only components 11, 12, 13 are selected for which all the time stamps are within the display period DP, and in the case of a specific time period, will select the component if the specific time period is at least fully inside the display period DP. For example, a to-do list can be a data source component 11, 12, 13, and the to-do list can have a date of creation, and have a series of due dates for the tasks that need to be done. In such case, it would be possible to display the to-do list as long as any one of the dates is still within the display period DP. In the variant shown, step S20 of filtering data source components based on criteria is performed first to generate or update first table T1, and thereafter, the step S40 is performed to discard data source components to generate or update second table T3. However, it is also possible that first data source components are discarded by step S40, and thereafter, the data source components are filtered by step S20. Also, in a variant, instead of performing a first filter based on context C, user U, and privacy P with step S20 to generate first table T1, and thereafter perform a second filter based on time T to generate third table T3, it is possible that these two steps are merged together and regularly updated at the same time, to generate third table T3 directly from master index table T0 based on all factors U, P, C, G, and T. Also, it is within the scope of the invention to create a user-specific master index table T0. Also, it is possible that the filtering of the master index table T0 is performed step-by-step on different criteria based on user U, privacy P, context C, geography G, and time T, not necessarily limited to this order.

Next, once third table T3 has been defined listing data source elements 11, 12, 13, step S50 is performed in method M100, in which the graphical user interface 340 and the layout of the displayed events E in interface 340 are generated. Each displayed event E corresponds to a respective data source component 11, 12, 13. In this step, all the events listed in third table T3 will be organized and displayed as events E to create an at-glance summary, and no further filtering to reduce the number of data source components 11, 12, 13 will be performed. The interface 340 will not be scrollable and will show all events E of table T3 so that information can be easier overviewed, at one glance, and none of the events E will overlap or not be viewable on the screen. Also, this step attempts to optimize the usage of the surface area of the interface 340, so that substantially the entire surface area is covered with events E, with exception of the spaces between different events E, and between events E and outline O of interface 340. The size of the surface area of graphical user interface 340 will be used to define the layout and the size of each icon or graphical object representing the event E that is displayed.

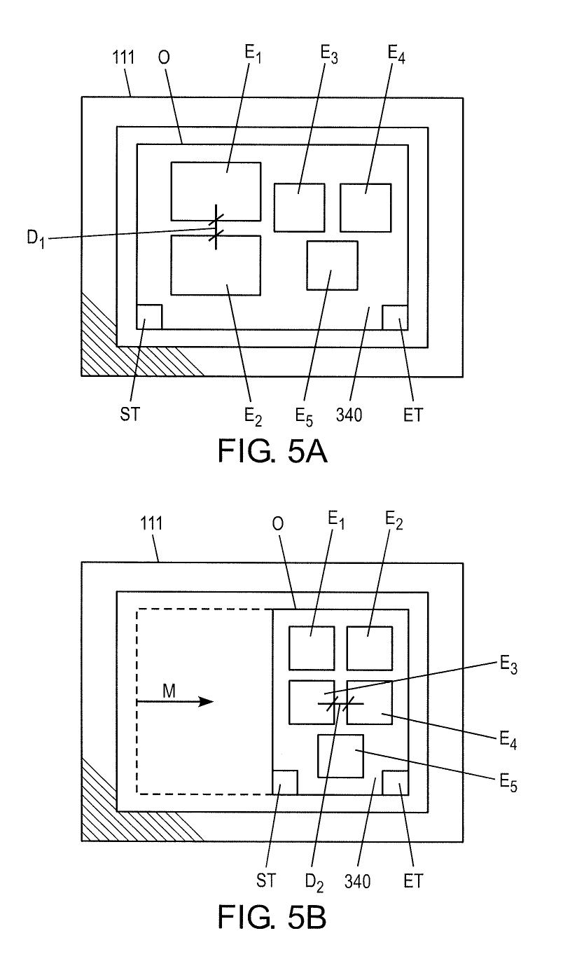

FIG. 5A shows an exemplary graphical user interface 340 with selectable events E₁ to E₅ corresponding to respective data source components. Also, the graphical user interface 340 shows start time ST and end time ET. User U changes the size of the graphical user interface 340, for example by a movement M of an edge of outline O by a mouse, selection tool, cursor, or finger swipe to reduce a surface size of interface 340. Consequently, less surface area of the screen of the data visualization device 111 will be used by interface 340, the events E will be automatically rearranged and changed in size so that all events still fit inside the newly defined area of interface 340, with no event E overlapping and none of the events E being dropped from the display. The change of outline O by user will automatically trigger a rearrangement of the events E by step S50. As shown in FIG. 5B, interface 340 has been reduced is size by approximately 50% by a mouse or swipe with movement M, and thereafter, events E₁ and E₂ are reduced in size by about 40% and are displayed close to the upper border of interface 340, and events E₁ to E₃ have been slightly reduced in size of about 20% and are fitted in the lower section of interface 340.

With step S50, as the size of the interface 340 is reduced, generally all the sizes of the areas occupied by icons of events E is reduced, but it is also possible to selectively reduce area sizes of the icons or graphical objects representing events E, in which some are reduced, and others not. In another variant, the size reduction factor can be different for different types of events E. For example, data source components 11, 12, 13 can also be classified by metadata on their size and display priority, for example, different types of data source components 11, 12, 13 can be given a classification as to their importance of appearing larger, and not being reduced in size as much as compared to other data source components, when displayed as events E. For example, a value can be associated to data source components with 1=should appear smaller in average than other events, 2=should appear in similar size in average as other events, or 3=should appear larger in average than other events when simultaneously displayed on interface 340. Also, data source components can have data associated thereto as metadata that give them priority as to their display position, and can be also associated with metadata that define a preferred display aspect ratio between height and width of the displayed event E.

Moreover, the average distance D between adjacent events E can also be adjusted upon changing of the size of the area of the interface 340. For example, as shown in FIGS. 5A and 5B, minimal distance D₁ between adjacent events E is reduced to minimal distance D₂ as the surface area of interface 340 is reduced by 50%. For example, the minimal distance between two adjacent events can be made proportional to the available surface area of interface 340. Similarly, a distance between any of the events and the outline of the graphical user interface 340 can be reduced as the available surface area of interface 340 is reduced. Vice-versa, if a user U increased the display surface area of the interface 340, the sizes of events E is increased to substantially fill out the surface area of interface 340, and the average distances D can also be increased.

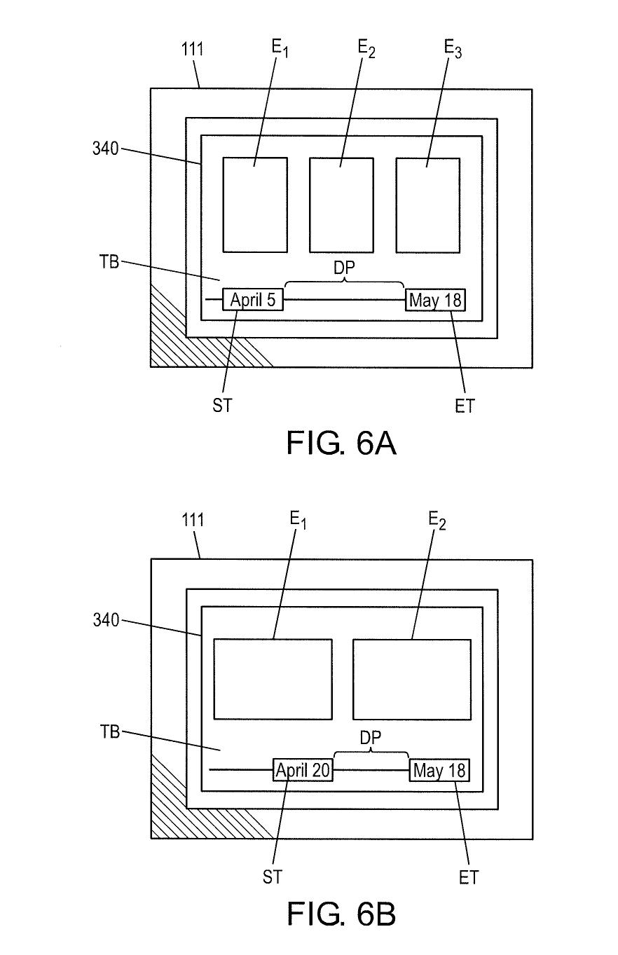

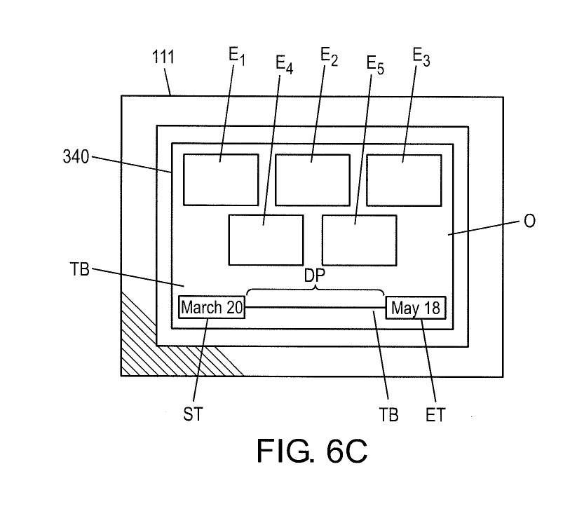

Next, FIGS. 6A, 6B and 6C show a data visualization device 111 in which the display period DP has been changed, so that the number of displayed events E is modified. FIG. 6A shows interface in which a display period DP is set with start time ST of April 5 until end time May 18. In this DP, three events E₁ to E₃ are found in third table T3 that fit within this DP. Next, the user U moves slider for ST to the right so that the display period DP is shorted, the ST now being April 20, as shown in FIG. 6B. As event E₃ has a time-stamp that is outside this newly defined DP, event E₃ is dropped from the interface 340, and events E₁ and E₂ that are still within the shortened display period DP are resized to be larger and to substantially fill the surface area of the interface 340. The change of the DP triggers step S40 that will discard data source components from third table T3 that are outside the newly defined DP, and step S50 calculates the new display arrangement of events E₁ and E₂. Next, as shown in FIG. 6C, the start time ST slider is moved to March 20, so that the DP is longer than the initially defined DP. This change of DP triggers the update of the third table T3 by step S40 to add data source components 11, 12, 13 to table T3 from first table T1, and the recalculation and aggregation of a new arrangement of events E, in which five events E₁ to E₅ are shown, all having underlying data source component data that have a time-stamp within the DP. Also, the display area size of events E₁ to E₅ has been reduced to fit inside outline O of interface 340 without any overlap. In a variant, the location where the start time ST and the end time ET are displayed are fixed into the bottom left and right corners, as shown in FIG. 4, and the display period DP is displayed in the middle between the ST and the ET. The ST and the ET can be varied by clicking on the ST and ET icons, and by a pop-up window that allows modifying these times.

Step S60 of method is performed to display the events E that are defined in step S50, and to manage and control the graphical user interface by data visualization device 111, and the graphical user interface 340 is active for user interaction, as shown in FIG. 4, FIGS. 5A-5B and 6A-6C. At least some of events E are selectable and expandable graphical elements upon selection by user U, as further explained below. Moreover, step S60 manages the data input elements, such as but not limited to table 114, control bar CB, and the elements showing start time ST and end time ET. At start-up of the at-glance visualization method with device 111, interface 340 can display default values for start time ST and end time ET that define the display period DP. These times can be entered manually by selecting a dates and times on a pop-up interface showing a calendar, or by using sliders on a time scale, one slide representing the start time ST, and one slider representing the end time ET, each of which can be slid along the time scale to change DP by a swipe or by using a mouse. It is also possible that the display period DP is defined by a time moment and a time period associated thereto, for example, the start time, intermediate time, end time, and a time period associated thereto. Thereafter, this display period DP including start time ST and end time ET is communicated to step S40 so that the third table T3 can be updated, by either further discarding entries with data source components 11, 12, 13 that are outside DP, or by adding additional entries with data source components 11, 12, 13 that are now inside the enlarged DP. In addition, step S60 can also use third party applications, software, objects or plug-ins to generate the icon or the graphical object that represent the events E, or may also use proprietary software to display certain events.

As shown in FIG. 4, different events are shown with interface 340 that is shown in a browser operated on a Windows™ operating system. The exemplary displayed events E include a math grade score 310, vacation photo album 312, a text block 314, a scanned handwritten recipe 316, a tracked running route 318, a do-to list with time-stamp 320, a family photo album from an evening at a lake 322, a graph showing the timely evolution of the user's weight 324, mapping information on a business trip 326, location tag with a map 328, an image gallery with paintings 330, and a virtual three-dimensional space of an art museum 332. In the upper right corner of interface 340, the control bar is arranged, allowing the user to log in and out, and also permitting the user to make settings, tag specific events, add new context C categories and tag events E. In the lower section of interface 340, the start time ST and end time ET are displayed, that can be modified by selecting the icons representing the ST and the ET, and the display period DP is shown in the center between the icons representing the ST and the ET. The display period DP can also be directly modified by selecting the icon for the DP, and by choosing a different period, starting at start time ST, or ending at end time ET. This can be done by a pull-down menu that allows to change the DP settings, for example to predefined fixed time periods such as one week, one month, three months, one year, five years, your-to-date, or by directly entering a desired DP by user U.

The icons or graphical objects that are used to display events E as shown in FIG. 4 are not just representative symbols, but actually show underlying content data of the data source components 11, 12, 13 that are associated to the respective events E. For some events, the graphical object can show the entire content data, for others, the content data is reduced to fit the available surface area for event E. As an example, event 314 shows the entire data entry of the text block “Hello world,” while event 324 may show a graph with a reduced resolution of the evolution of the weight of user U. Also, mapping information of events 326 and 328 may show the location information, but the mapping information is sized and formatted for the available surface area of these respective events. Moreover, a photo shown in event 312 may be a single photo of an entire photo album as underlying data source component, and the photo shown may be reduced in resolution for fitting the space accorded to the graphical object. Also, in a case video is displayed as event E, it is possible that the video is represented by a single image, or is actually played so that user U can have an idea of the contents of the video. The playback of the video is also formatted to fit the resolution of the displayed event E. Moreover, step S60 is further configured such that displayed events E can also be labeled with an identifier that is displayed, for example a number 313, or can also be labeled by the time T associated to the underlying data source component 11, 12, 13, displayed on graphical object representing event E. This way, step S60 of the at-glance visualization method or system is configured to visualize in one a single, non-scrollable display screen a summary of content data, without any overlapping graphical objects or elements of events E that would hide some of the content data, based on a given time period DP. Also, displayed events E cannot be moved to cover the control bar CB, or the time bar TB.

The exemplary screenshot of FIG. 4 shows various events that are all personal to a single user U. In this summary of events that are displayed on graphical user interface 340, it is also possible that non-secured and secured data is displayed, and the summary of events shows events E of non-secured data, and events E having secured information. As an example, one event E my display photos from a vacation like photo album event 312, being data that is merely compressed, but may not secured or encrypted. Moreover, it is also possible that another user U makes his data available to user U, and can thereby see events E that the other user has shared. Another event E may display medical records showing doctor visits, prescribed medication, and health costs records in an event, data that is private, secured from access by passwords and usernames, and encrypted. For this purpose, step S10 can employ a module or object that can use secure data communication protocols, such as secured socket layer (SSL) protocol, network security services (NSS) protocol, transport layer security (TLS) protocol and corresponding APIs, or a similar data security technology, to access such data from a secured server, for example a medical records server, pharmacy database, hospital center, healthcare provider. In addition, step S10 can employ data decryption technology, such as but not limited to RSA encryption, hashed data, pre-shared key (PSK), and stored decryption keys locally at the data visualization device for decrypting secured content. Accordingly, step S10 uses objects, agents or modules that are configured to access data as secured webservers, and also to encrypt and display such data.

Also, step S60 allows the user to select different events E, and to provide for additional tags in the form of metadata to the events. For example, it is possible that a user wants to categorized certain displayed events E that are currently not classified in any common context C into a new category of context C. For this purpose, the user can choose a menu from the control bar CB, generate and name a new context C, and thereafter, select the events E that should become part of the new context C. As an example, it is possible that a user U would like to meetings of a club into a separate context C, being various heterogeneous data sources such as but not limited to location tags, photos, tracking data. Next, the user can also set certain preferred display settings for events E. For example background color for the icons or layouts of that present the events can be chosen. User U can also set preferred dimensions for individual icons of the events E, for example by setting a preferred size, a preferred aspect ratio, preferred location on the screen of data visualization device 111.

Also, steps S40 of adding and discarding data source components 11, 12, 13 to third table T3, and subsequently, the step S50 of configuring the arrangement of events E are performed with a very short latency time and with high processing priority, preferably by a graphics processor of data visualization device 111, to assure that changes in the display period D and changes in the display size of graphical user interface 340 have an immediate effect on the display and are swiftly changed for enhanced user ergonomics and esthetics. Preferably, a change that is triggered by data input with step S60 that will start operation of steps S40 and S50 should be processed in a latency time that is shorter than 20 ms, more preferably shorter than 10 ms, to be able to provide for a fast and smooth updated arrangement of events E in graphical user interface 340.

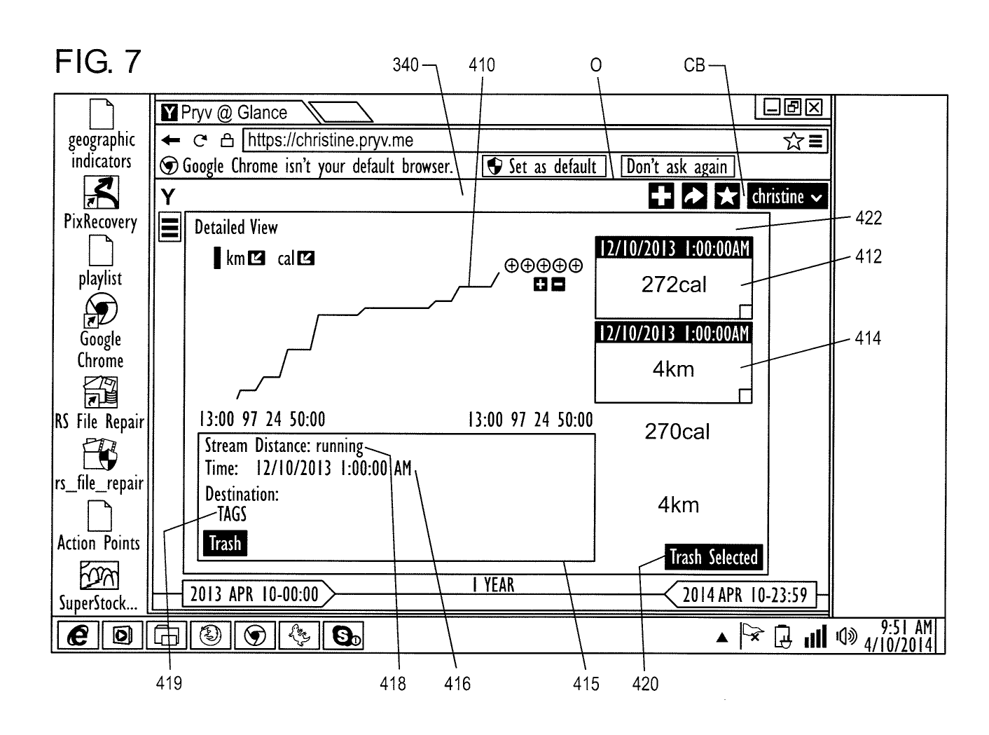

FIG. 7 shows a representative screen shot of the graphical user interface 340, after one of the displayed events E has been selected by user U. In the variant shown, a user U has selected event 318 of FIG. 4, for example by a double mouse-click, by touching the event with his finger on a touchscreen, to expand the view on the selected event for a detailed view. The selected event 318 is thereby expanded to substantially fill out the entire outline O of interface 340, the control bar CB and the time bar with start time ST and end time ET still being visible, but all the other events that have not been selected have become invisible. This expanding of an event E to show a detailed view upon selection by user U is also managed by step S60. By selecting event 318, more data becomes available; showing two overlapping time graphs 410 of two different running occurrences, associated data such as calories burned 412, and distance run 414. Also, the selected and expanded event has a trash or delete button 420 that allows discarding the event from the graphical user interface 340, and the deletion of the event from first and third tables T1 and T3. Moreover, an information block 415 is provided in which different metadata that is associated with the underlying data source component can be displayed, including a title 418 or label of the component, the time T (416) associated to the component, tags that belong to context C, additional description. Upon selecting icon 422, the expanded and detailed view of event 318 collapses again, and the graphical user interface returns to the summary view with all events as shown in FIG. 4.

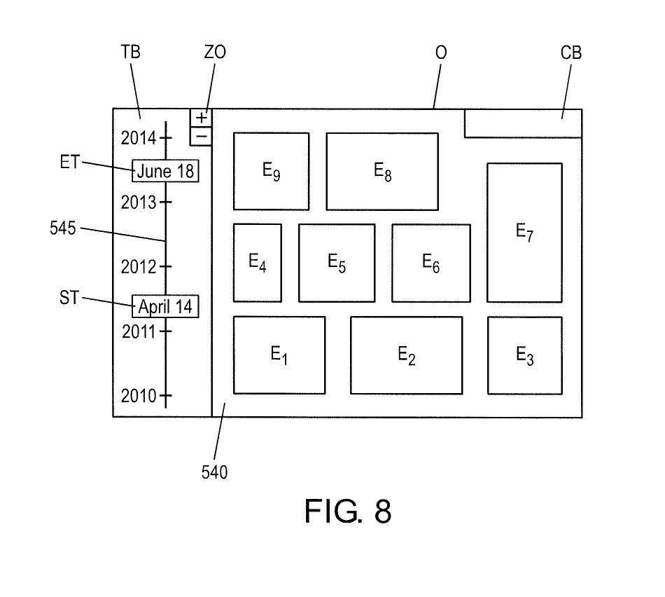

FIG. 8 shows another exemplary and schematic view of a graphical user interface 540 according to another aspect. In the variant shown, events E₁ to E₈ are shown in a central area of interface 540, with a separate time bar TB having a two sliders ET and ST for defining the display period DP by the start time and the end time. The specific time instance that corresponds to the position of the sliders is displayed inside sliders ET and ST. A time line 545 is displayed and labeled with a time scale, for example individual years, and a zoom tool ZO allows to zoom in and zoom out of the scale of the time line 545. The separate time bar TB and the control bar CB do not vary in size and are fixed in size and location inside interface 340, while the arrangement and display of events E will change as the DP is changed and certain events are dropped or added.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

1. A method for graphically representing information on a display, comprising the steps of:
displaying a first icon associated with a start date;
displaying a second icon associated with an end date;
displaying an first object that is associated with a first date that lies between an interval of the start date and the end date;
displaying a second object that is associated with a second date that lies between the interval of the start date and the end date;
changing at least one of the start date and the end date such that the first date lies outside the interval of the start date and the end date; and
removing the display of the first object.

2. The method according to claim 1, wherein
the first object is a trajectory referenced to a map and a corresponding map, and the first date is a date during which the trajectory was made.

3. The method according to claim 1, wherein
the first object is a graph showing a distance information as a function of time associated with an activity, and the first date is a date during which the activity was made.

4. The method according to claim 1, wherein
the first object is a photograph and the first date is a date at which the photograph was taken.

5. The method according to claim 1, wherein the first icon and the second icon do not overlap each other in the display.

6. The method according to claim 1, further comprising a step of:
increasing a display area size of the second object inside the display, after said first object is removed.

7. A method for graphically representing information on a display, comprising the steps of:
accessing first information from a storage device, the first information related to a time-variable function and displaying the time-variable function as a graph in a first field of a graphical user interface having a display area;
accessing second information from the storage device, the second information being image information and displaying the image information as an image in a second field of the graphical user interface; and
resizing the graph and the first field and the image and the second field so that the first field and the second field fit inside the display area of the graphical user interface.

8. The method according to claim 7, further comprising the steps of:
accessing third information from the storage device, the third information being map information and displaying the map information as a map in a third field; and
resizing the graph and the first field, the image and the second field, and the map and the third field so that the first field, the second field, and the third filed fit inside the display area of the graphical user interface without any overlap between the first and the second field.

9. The method according to claim 7, further comprising the steps of:
changing a size of the display area of the graphical user interface; and
resizing and moving the graph and the first field and the image and the second field so that the first field and the second field fit inside the changed display area of the graphical user interface.

10. The method according to claim 7, wherein the display area is not scrollable such that the first and the second field are fully represented in the display area graphical user interface.

11. A non-transitory computer readable medium having computer instructions recorded thereon, the computer instructions configured to perform a method when executed on a computer, the method comprising the steps of:
displaying a first icon associated with a start date on a display;
displaying a second icon associated with an end date on the display;
displaying an first object that is associated with a first date that lies between an interval of the start date and the end date on the display;
displaying a second object that is associated with a second date that lies between the interval of the start date and the end date on the display;
changing at least one of the start date and the end date such that the first date lies outside the interval of the start date and the end date; and
removing the display of the first object from the display.
